(19) United States
(12) Patent Application Publication
(10) Pub. No.: US 2005/0274115 A1
(43) Pub. Date: Dec. 15, 2005

(54) Method and Apparatus for Prevention of Compressor Stall and Combustion Flameout in a Turbine Engine

(76) Inventor: Kevin P. Pearce, Johnstown, PA (US)

Correspondence Address: KEVIN P. PEARCE, 136 SHENKLEVIEW DRIVE, JOHNSTOWN, PA, 15905, US

(21) Appl. No.: 10/710,057

(22) Filed: Jun. 15, 2004

(51) Int. Cl. F02C 9/28

(52) U.S. Cl. 60/773; 60/39.281

(57) ABSTRACT

This invention is a means for preventing loss of flame and compressor section instability in a turbine engine. The invention uses an Electronic Control Unit to modify the fuel system demand signal to the final controlling element or elements of a turbine engine to prevent rapid changes either for increasing or decreasing the amount of fuel to the engine. The invention offers the simplicity and reliability of electronic control over previously used mechanical means such as dashpots, variable orifices, springs, and cams. The use of an electronic delay means further allows for reduction in the weight of the overall engine due to elimination of the mechanical apparatus, the ability to change the delay constants in a simple fashion by changing a preprogrammed value rather than physically changing the mechanical hardware, and the ability to have one or more differing delay rates for increasing or decreasing fuel delivery and operating conditions.

### BACKGROUND OF INVENTION

One of the limitations in variable speed applications of turbine engines such as are utilized in aircraft during takeoff and landing, for example, is the problem of either creating a condition commonly referred to as compressor stall when the quantity of fuel delivered is increased too rapidly or causing flameout of the combustion process when the quantity of fuel delivered is decreased too rapidly.

Various means have been used to attempt to predict the onset of compressor stall by monitoring some function of the engine. U.S. Pat. No. 3,938,319 (“Method and Apparatus for Preventing Compressor Stall in a Gas Turbine Engine”) senses the pressure differential across a stage or stages of the compressor. An indication of impending compressor stall is a rapidly fluctuating pressure gradient between the intake and exhaust of a stage of the compressor caused by air moving in a laminar flow stream in the un-stalled condition and a turbulent flow stream during a stalled condition. Upon sensing this condition, fuel is restricted to the combustion area of the engine to cause the compressor to exit the potential stall condition. U.S. Pat. No. 4,825,639 (“Control Method for a Gas Turbine Engine”) is also predicting an impending compressor stall condition by monitoring the pressure gradient but increases the amount of bleed air from the compressor rather than reducing the quantity of fuel to regain control. U.S. Pat. No. 6,591,613 (“Methods for Operating Gas Turbine Engines”) follows the same concept of restricting fuel to maintain compressor stability but achieves this by monitoring exhaust gas temperature.

In an attempt to predict an impending loss of combustion U.S. Pat. No. 4,009,567 (“Delayed Ramping in the Primary Control System or Local Maintenance Controller of a Gas Turbine Implemented Electrical Power Plant”) prevents the rapid closing of the fuel supply control valve(s) in response to a rapid increase in turbine shaft speed encountered when ignition is first established and is only active during initial light off. U.S. Pat. No. 5,896,736 (“Load Rejection Rapid Acting Fuel-Air Controller for Gas Turbine”) rapidly restricts the amount of combustion air in response to a sudden decrease in load on a turbine used for power generation. A sudden loss of load would cause a sudden increase in shaft speed. In reaction to the sudden increase in shaft speed the fuel controller would reduce fuel supplied to maintain a desired shaft speed; therefore, a sudden reduction in the amount of combustion air is needed to maintain the fuel-air mixture within an ignitable range.

In all of the aforementioned prior art, means have been derived which sense some operating parameter of the engine such as compressor pressure, exhaust temperature, or shaft speed. In all of these cases, the objective of the inventions is to react to some operating parameter after that parameter has reached a predefined undesirable operating point and to then control some aspect of the combustion process to cause the undesirable parameter to be corrected.

The objective of this invention is to prevent compressor stall or loss of combustion conditions by preventing an excessively rapid increase or decrease in fuel delivery to the engine regardless of the rate of change of the demand signal to the fuel control system. Preventing an excessive rate of change in the fuel delivered to the engine eliminates the need for pressure taps and sensors, exhaust gas temperature monitoring equipment, shaft speed monitoring equipment, and other types of supervisory inputs to the fuel system thus simplifying the overall complexity of the engine along with eliminating maintenance on the sensing elements. Especially beneficial in the utilization of turbine engines in aviation applications is the reduced weight of the engine and the reduction in the amount of subsystems and actuators, each of which having a potential to fail to operate.

### SUMMARY OF INVENTION

This invention is an apparatus and method for controlling the rate of change in the quantity of fuel injected into the combustion chamber of a turbine engine. The apparatus comprises an electronic control unit to generate a fuel flow signal to some regulating device, said device comprising one of a group of a metering valve, metering pump, or electrically controlled fuel injector, said electronic control unit being capable of controlling the rate of change of the output fuel signal independently of the rate of change in the demand signal for an increase or decrease in fuel to said engine, said electronic control unit comprising one of a group of a programmable microcomputer or microcontroller; a program resident within said electronic control unit or available to same containing independent preset ramping rates for increasing or decreasing fuel delivery changes as required of said electronic control by an external demand input. The method for controlling the quantity of fuel delivered to the combustion chamber of a turbine engine comprising the steps of receiving and interpreting an input signal for fuel demand from some external source; upon processing said demand signal, causing a delay in the rate of increase or decrease of fuel supplied based upon a resident or accessible preset program; and supplying an output to the fuel control element or elements actuating system to cause a change in the quantity of fuel delivered to said combustion chamber of said turbine engine at an increasing or decreasing rate independent of the rate of change required by said demand signal.

### BRIEF DESCRIPTION OF DRAWINGS

FIG. 1 is a block diagram of the interaction between the demand signal, the electronic control unit, and the fuel metering device.

FIG. 2 is a flow chart of the logic flow within the electronic control unit.

FIG. 3 is simplified version of the flow chart of FIG. 2 to illustrate the ability, if desired, to trigger the use of differing delay times by the occurrence of some external event.

### DETAILED DESCRIPTION

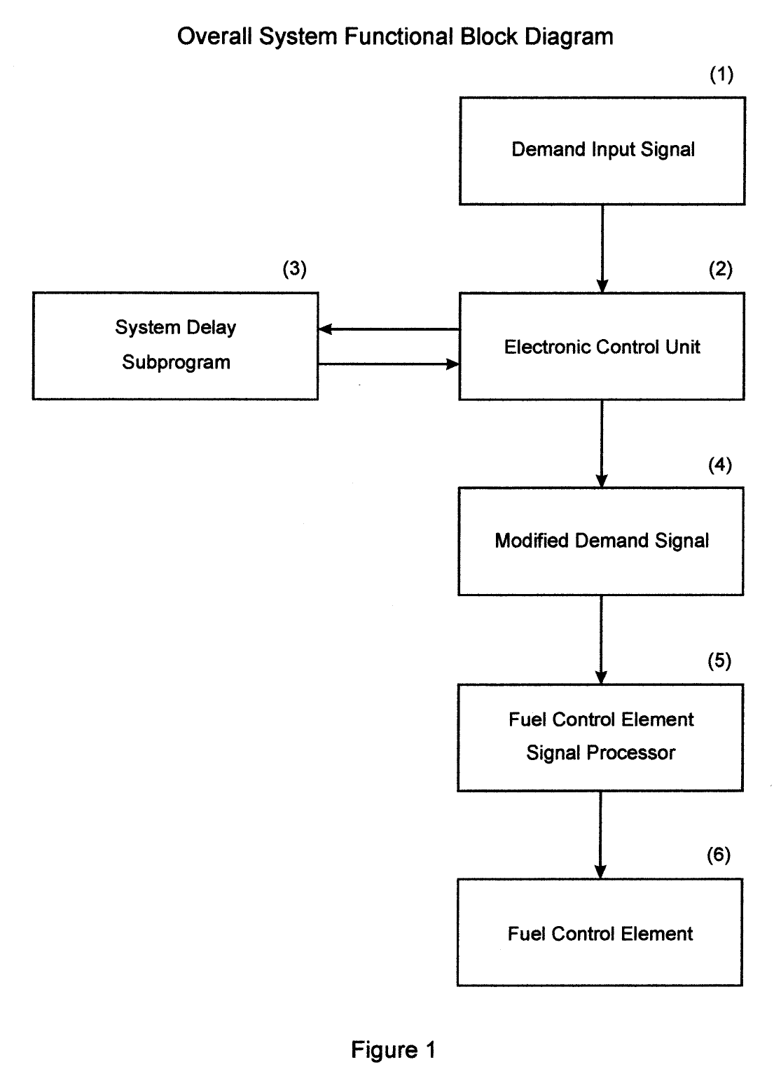

Referring to FIG. 1 which depicts the interaction of the Electronic Control Unit 2 with the other component parts of the overall fuel supply system. The overall fuel supply system needs, as the first step in control, to be provided a Demand Input Signal 1 from some external source. Depending upon the application, this signal will be from some external source such as a manually controlled throttle to indicate a power set point, a speed signal to indicate a desired RPM level, a temperature signal, or any similar source to provide some desired overall operating characteristic of the engine. Once the signal is converted into an input that the Electronic Control Unit 2 is capable of operating upon, the Electronic Control Unit 2 interfaces with the System Delay Subprogram 3, said System Delay Subprogram being either a portion of the Electronic Control Unit 2 or a separate system which is capable of interacting with the Electronic Control Unit 2 as desired. The Electronic Control Unit 2 works together with the System Delay Subprogram 3 to determine if a preset delay time has been achieved and, if so, the original Demand Input Signal 1 is changed as needed and now becomes the Modified Demand Signal 4. In a case where the preset delay time has not been achieved, the existing Modified Demand Signal 4 is left unchanged. Once a newly created or existing Modified Demand Signal 4 is determined it is sent to the Fuel Control Element Signal Processor 5 where it is used to provide an operating signal in some form usable by the Fuel Control Element 6.

Existing systems all utilize some form of Demand Input Signal 1 along with a Fuel Control Element Signal Processor 5 to interpret the supplied signal and convert said signal into some type of output to provide a means to actuate the Fuel Control Element 6. In a simple, rudimentary, system such as a fixed displacement pump, the Demand Input Signal 1 could be the turbine shaft driving a gearbox which through its gearing would function as a Fuel Control Element Signal Processor 5 with the output of the gearbox driving the pump as a Fuel Control Element. Similar types of interactions would include such things as a motor operated valve, pulsed direct fuel injection whose pulse width is controlled by a rheostat, an air operated valve controlled by a pressure regulator, among various other possibilities. The novelness of this invention is inserting the Electronic Control Unit 2 and the System Delay Subprogram 3 into the process loop to override, when needed, the original Demand Input Signal 1 to protect against undesired operation of the engine, such as loss of flame from decreasing the fuel supply too rapidly or compressor stall from increasing the fuel supply and consequently increasing the compressor speed too rapidly.

Prior art has utilized mechanical means such as cams, springs, and dashpots to accomplish some form of delay. U.S. Pat. No. 4,503,670 (“Deceleration Limiter, Particularly for a Turbine”) describes one type of mechanical system to achieve a delay type of function and additionally describes other prior types of mechanical devices along with the undesirable limitations of inherent manufacturing and operational complexity. By interposing the Electronic Control Unit into the process loop, (1) the mechanical complexity of prior art is eliminated, (2) the reliability inherent in solid state electronics is gained, (3) the ability to change the delay times for different applications by simply changing a stored value rather than changing a mechanical constant such as the size of an orifice, the profile of a cam, or the force required to compress or extend a spring, and (4) the ability to utilize differing independent delay times for increasing fuel demand, decreasing fuel demand, or different operating conditions.

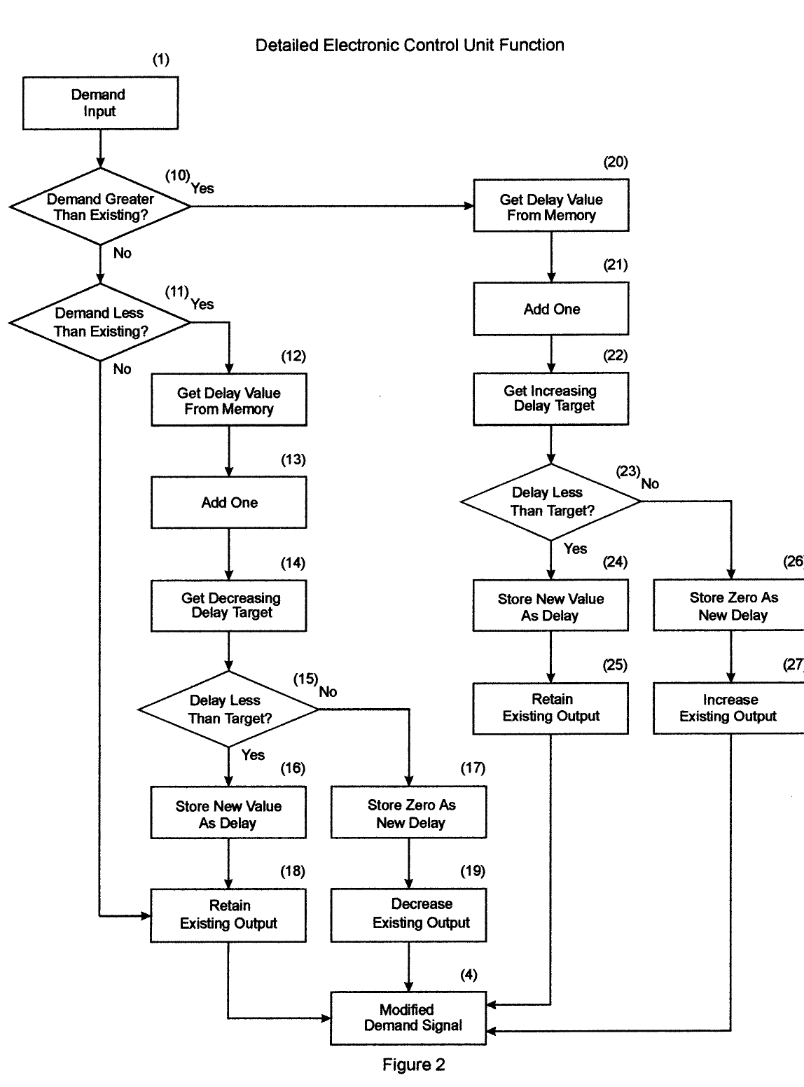

Referring now to FIG. 2 is a flowchart of the functional operation of a typical Electronic Control Unit and System Delay Subprogram as was generally discussed in FIG. 1. Only the function of the Electronic Control Unit relating to modifying and delaying the demand signal are being discussed. The Electronic Control Unit could be, but is not required to be performing additional functions such as monitoring exhaust gas temperature, generating a tachometer signal to the operator, or displaying status of the engine or overall system as some examples. The delay function of the Electronic Control Unit would be called upon to function when triggered by some external or internal event such as a change in the Demand Input Signal 1, an external clocking device or timer, or the Electronic Control Unit's internal clock.

The first step in the sequence is the receipt by the Electronic Control Unit of an input signal which is either in a usable form or is immediately changed to a usable form and becomes the Demand Input 1. In the simplest traverse through FIG. 2 the first decision to be made is whether the new Demand Input 1 is Greater Than Existing 10, if not, the Demand Input 1 would be checked to verify that it is not Less Than Existing 11. If both of these checks are true, no change would be made to the existing output and the Demand Input 1 would be passed through, unchanged, by way of the action Retain Existing Output 18 which would leave the Modified Demand Signal 4 in its existing state. This is the path which would be followed during steady state operation.

In the case where, upon checking the Demand Input 1 and finding that it is Greater Than Existing 10, the delay function of the program is activated. The program first will Get Delay Value From Memory 20 and Add One 21. Next, the program will Get Increasing Delay Target 22 and compare the newly incremented delay with the delay target. If the Delay Less Than Target 23 condition is true, the original Get Delay Value From Memory 20 after being previously modified by Add One 21 is retained as Store New Value As Delay 24 and the action Retain Existing Output 25 would leave the Modified Demand Signal 4 in its existing state. If after comparing the newly incremented delay with the Get Increasing Delay Target 22 it was found that the test Delay Less Than Target 23 condition is false, the system would then Store Zero As New Delay 26 to reset the delay chain and then Increase Existing Output 27 by some preprogrammed value which would now cause the Modified Demand Signal 4 to be increased.

In the case where, upon checking the Demand Input 1 and finding that it is greater than the existing, the delay function of the program is activated in the same manner as was the case discussed in the preceding paragraph. The two differences in the paths are that Modified Demand Signal 4 would be decreased if the Get Decreasing Delay Target 14 has been met and that value of Get Decreasing Delay Target 14 need not be the same as the value of Get Increasing Delay Target 22. The ability of the invention to operate with different delay target values allows the engine or system designer the flexibility of considering the type of load being driven by the engine to tune the control system for optimum response and stability.

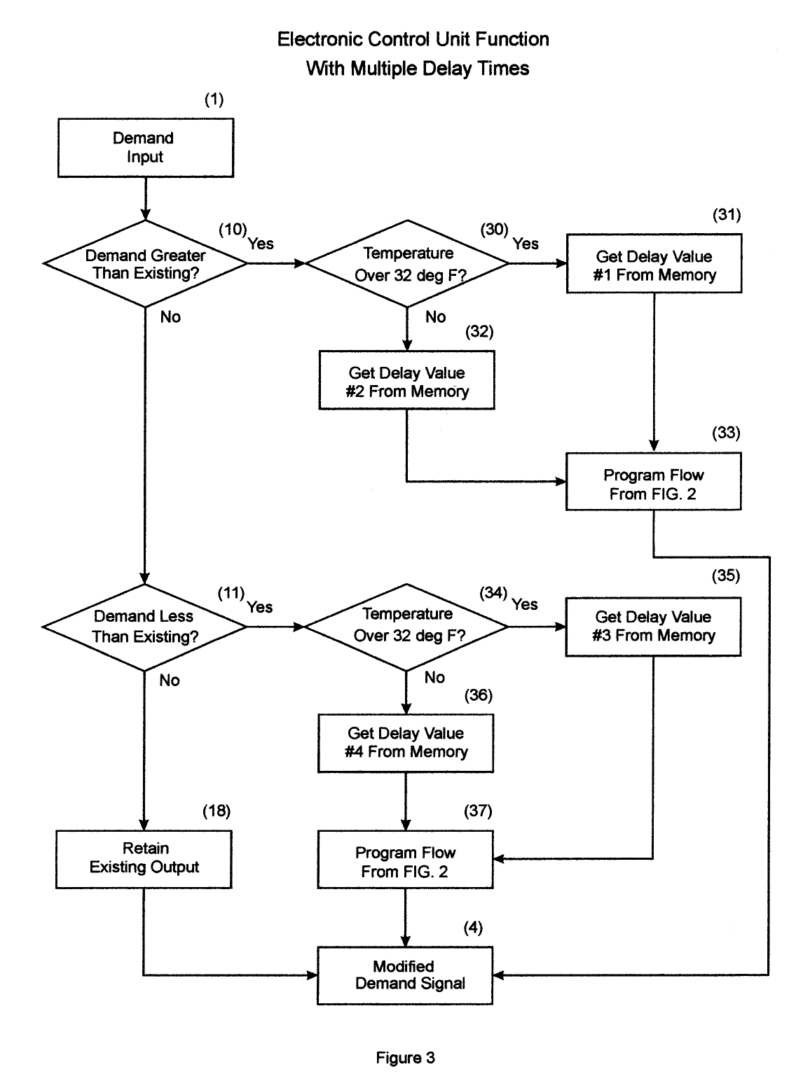

Referring now to FIG. 3 is a simplified version of FIG. 2 showing the ability to utilize more than one increasing and more than one decreasing delay time if desired in a given application. For clarity, only the overall concept of the logic used to determine which delay target is to be used is illustrated, the intervening steps of incrementing the delay value, storing and resetting the delay value, and the like are all the same as in FIG. 2. In the example illustrated in FIG. 3 the external triggering device is ambient temperature. The interaction of the invention to the external trigger condition is not limited to ambient temperature; if desired, a parameter such as shaft speed, percent of available engine output, barometric pressure or a combination of conditions may be used.

As was the case in FIG. 2, the first step in the sequence is the receipt by the Electronic Control Unit of an input signal which is either in a usable form or is immediately changed to a usable form and becomes the Demand Input 1. In the simplest traverse through FIG. 3 the first decision to be made is whether the new Demand Input 1 is Greater Than Existing 10, if not, the Demand Input 1 would be checked to verify that it is not Less Than Existing 11. If both of these checks are true, no change would be made to the existing output and the Demand Input 1 would be passed through, unchanged, by way of the action Retain Existing Output 18 which would leave the Modified Demand Signal 4 in its existing state. This is the path which would be followed during steady state operation.

In the case where, upon checking the Demand Input 1 and finding that it is Greater Than Existing 10, the delay function of the program is activated. Once it has been determined that Demand Greater Than Existing 10 is true the second parameter is tested. In the example under discussion the parameter in question is ambient air temperature. If the Temperature Over 32 deg F. 30 is true the program flow would be instructed to utilize Get Delay Value #1 From Memory 31 and would use that value to perform the Program Flow From FIG. 2 33. Program Flow From FIG. 2 33 consists of steps Add One 21 through Increase Existing Output 27 all from FIG. 2 as previously discussed to create, if needed, a Modified Demand Signal 4. In the case where, upon checking the Demand Input 1 and finding that it is greater than the existing, the delay function of the program is activated in the same manner as was the case discussed in the preceding paragraph. Now, upon testing the second parameter Temperature Over 32 deg F. 30 and finding the test to be false the program flow would now be instructed to utilize Get Delay Value #2 From Memory 32 and would use that value to perform the Program Flow From FIG. 2 33 in an identical fashion as the preceding paragraph.

The same program flow would occur if Demand Less Than Existing 11 would be true. In this case the system would now choose between Get Delay Value #3 From Memory 35 or Get Delay Value #4 From Memory 36 depending upon the outcome of testing Temperature Over 32 deg F. 34. FIG 3. illustrates the ability of the invention to be programmed to utilize not only differing delay times for increasing and decreasing fuel demands but the further ability to tailor said delay times based upon the occurrence of one or more external events. In the example discussed in FIG. 3 the ambient temperature was utilized as the hypothetical external event. The external event or events may be combined and tested in multiple fashions dependant upon the operational characteristics of the engine and is limited only by the size of memory available to the Electronic Control Unit and the desired complexity of the program. For example, if it is determined that a given engine needs a longer delay when the ambient air temperature is below some necessary set point but only when its current operating point is at a power level less than some set point the program would use one delay; if the conditions are ambient air temperature below said temperature set point but the engine is currently operating at a power level greater than said power set point the program would use a different delay thus giving the system a flexibility of operation and simplicity unattainable in prior art.

1. An apparatus for controlling the rate of change in fuel delivery to the combustion chamber of a turbine engine independent of the rate of change demanded, said apparatus comprising:
an electronic control unit inserted within the signal path between an incoming external fuel demand signal and an outgoing signal to the fuel delivery control elements for said combustion chamber of said turbine engine;
a means to retain a stored set of values either within said electronic control unit or available to said electronic control unit for delaying the rate of change in the outgoing signal to said fuel delivery control elements.

2. The apparatus of claim 1 wherein said electronic control unit is selected from a group comprising at least one of a microprocessor and a microcomputer.

3. The apparatus of claim 1 wherein said electronic control unit is capable of delaying the rate of change of an output signal to said fuel delivery control elements independently of the rate of change of said incoming fuel demand signal.

4. The apparatus of claim 1 wherein the program utilized by said electronic control unit is either resident within said electronic control unit or available from an external source.

5. The apparatus of claim 1 wherein the delay constants utilized by said electronic control unit may be different for increasing and decreasing fuel demand calculations.

6. The apparatus of claim 1 wherein said delay constants utilized by said electronic control unit may be different for different operating conditions of said turbine engine.

7. The apparatus of claim 1 wherein said electronic control unit is capable of selecting the correct said delay constant in response to said different operating conditions of said turbine engine.

8. The apparatus of claim 1 wherein said electronic control unit is an independent unit acting alone.

9. The apparatus of claim 1 wherein said electronic control unit is a portion of a larger system performing additional functions.

10. A method for controlling the rate of change in the fuel quantity supplied to the combustion chamber of a turbine engine independent of the rate of change demanded, said method comprising the steps of:
receiving an input fuel demand signal;
determining which previously stored delay time is to be utilized in reaction to external inputs;
retrieving the correct said previously stored delay time as required by said calculation;
causing a delay in the rate of increase or decrease independent of said rate of change demanded utilizing said retrieved previously stored delay time; and
directing said delayed rate of increase or decrease to be directed to the fuel delivery control elements of said combustion chamber of said turbine engine.

11. The method of claim 10 wherein said delay is electronically created.

12. The method of claim 10 wherein said delay may be different for increasing and decreasing fuel demands.

13. The method of claim 10 wherein said delay may be different for different operating conditions of said turbine engine.

14. The method of claim 10 wherein said steps are accomplished by at least one of a group comprising a microprocessor and microcomputer.
